(19) United States
(12) Patent Application Publication
(10) Pub. No.: US 2016/0140279 A1
(43) Pub. Date: May 19, 2016

(54) METHOD AND DEVICE FOR DESIGNING ELECTRICAL CIRCUIT

(71) Applicant: Semiconductor Manufacturing International (Shanghai) Corporation, Shanghai (CN)

(72) Inventors: Guang ZHU, Shanghai (CN); Xianmin CHEN, Shanghai (CN); Guang Tao FENG, Shanghai (CN); Chia Chi YANG, Shanghai (CN)

(21) Appl. No.: 14/932,344

(22) Filed: Nov. 4, 2015

(30) Foreign Application Priority Data
Nov. 13, 2014 (CN) 201410640866.9

(51) Int. Cl. G06F 17/50

(52) U.S. Cl. CPC G06F 17/5072; G06F 17/5077; G06F 17/5009

(57) ABSTRACT

A method may be used for designing an electrical circuit. The method may be implemented using a device that includes hardware. The method may include the following steps: generating a schematic model that represents the electrical circuit; placing representations of a set of elements of the electrical circuit for forming a pre-route layout model; and using the pre-route layout model and a set of layout-dependent effect parameter values to perform a pre-route simulation. The set of layout-dependent effect parameter values may pertain to the set of elements of the electrical circuit.

### CROSS-REFERENCE TO RELATED APPLICATION

This application claims priority to and benefit of Chinese Patent Application No. 201410640866.9, filed on 13 Nov. 2014. The Chinese Patent Application is incorporated herein by reference in its entirety.

### BACKGROUND OF THE INVENTION

The present invention is related to a method and a device that may be used for designing an electrical circuit. The electrical circuit may be included in an electrical device, such as a semiconductor device.

In the manufacturing and/or operation of an electrical device, such as a complementary metal-oxide-semiconductor (CMOS) device, various layout-dependent effects may significantly affect characteristics (e.g., carrier mobility, threshold voltage, etc.) of the electrical device and therefore may significant affect the performance of the electrical device. The layout-dependent effects may be related to physical phenomena associated with arrangement of elements and adjacent elements in the electrical circuit of the electrical device. The layout-dependent effects may include, for example, one or more of effects of engineered stress, effects of local reflectivity on temperature during rapid thermal anneals, and lithographic effects on the physical shape of contact level (CA) vias, and subsequent electrical impacts. Additionally or alternatively, the layout-dependent effects may include one or more parasitic effects.

For optimizing the performance of the electrical device, in a process of designing the electrical circuit of the electrical device, parameters related to layout-dependent effects may be provided in a computer-implemented routed layout model that represents the electrical circuit of the electrical device. A circuit simulation may be performed using the routed layout model, and a schematic model of the electrical circuit may be revised based on a result of the circuit simulation. Iterations of circuit simulations and schematic model revisions may be performed for optimizing the layout design of the electrical circuit. Time and work required for the iterations may significantly affect the efficiency of the design and development of the electrical device.

### SUMMARY

One or more embodiments of the present invention may be related to a method that may be used for designing (a layout of) an electrical circuit. The method may be implemented using a device that may include hardware and/or software. For example the device may be a computer. The method may include the following steps: generating a first schematic model that represents the electrical circuit; placing representations of a first set of elements of the electrical circuit for forming a first pre-route layout model; and using the first pre-route layout model and a first set of layout-dependent effect parameter values to perform a first pre-route simulation. The first set of layout-dependent effect parameter values may pertain to the first set of elements of the electrical circuit.

The method may include adjusting the first schematic model based on a result of the first pre-route simulation to generate a second schematic model.

The method may include providing connections in the first pre-route layout model based on a result of the first pre-route simulation to generate a routed layout model.

The method may include adjusting the first pre-route layout model based on a result of the first pre-route simulation to generate a second pre-route layout model.

The method may include using the second pre-route layout model and at least one of the first set of layout-dependent effect parameter values and a second set of layout-dependent effect parameter values to perform a second pre-route simulation.

The method may include providing connections in the second pre-route layout model based on a result of the second pre-route simulation to generate a routed layout model.

The method may include the following steps: determining layout parameter values associated with the first set of elements of the electrical circuit based on a preliminary schematic model, wherein the layout parameter values may include one or more layout-dependent effect parameter values; before the placing, using the layout parameter values to perform a first pre-placement simulation; and adjusting the preliminary schematic model based on a result of the first pre-placement simulation to generate the first schematic model.

The first pre-placement simulation may involve using the preliminary schematic model.

The first pre-placement simulation may involve using an exclusive schematic model. The exclusive schematic model may represent a second set of elements of the electrical circuit other than the first set of elements of the electrical circuit. The first set of elements of the electrical circuit may include critical elements of the electrical circuit.

The method may include the following steps: using the layout parameter values and an exclusive schematic model to perform a second pre-placement simulation; and adjusting the first schematic model based on a result of the second pre-placement simulation. The exclusive schematic model may represent a second set of elements of the electrical circuit other than the first set of elements of the electrical circuit The first set of elements of the electrical circuit may include critical elements of the electrical circuit.

The method may include selecting the first set of elements of the electrical circuit. An element of the first set of elements of the electrical circuit may be more sensitive to a layout-dependent effect than an element of a second set of elements of the electrical circuit.

The first set of elements of the electrical circuit may include analog circuit elements.

The method may include placing representations of a second set of elements of the electrical circuit for forming the first pre-route layout model. The first pre-route simulation may further involve using a second set of layout-dependent effect parameter values. The second set of layout-dependent effect parameter values may pertain to the second set of elements of the electrical circuit. An element of the first set of elements of the electrical circuit may be more sensitive to a layout-dependent effect than an element of the second set of elements of the electrical circuit.

The first set of elements of the electrical circuit may include analog circuit elements. The second set of elements of the electrical circuit may include digital circuit elements.

The step of placing the representations of the first set of elements of the electrical circuit may include the following steps: automatically arranging the representations of the first set of elements according to an algorithm stored in the device; and after the automatically arranging, adjusting positions of the representations of the first set of elements according to user input.

One or more embodiments of the present invention may be related to a device that may be used for designing a layout of an electrical circuit. The device may include the following elements: a parameter value module configured to determine a first set of layout-dependent effect parameter values, wherein the first set of layout-dependent effect parameter values may pertain to a first set of elements of the electrical circuit; a simulation module configured to perform a first pre-route simulation using a first pre-route layout model and the first set of layout-dependent effect parameter values, wherein the first pre-route layout model may include representations of the first set of elements of the electrical circuit; a calibration module configured to adjust a first schematic model based on a result of the first pre-route simulation to generate a second schematic model; and hardware configured to perform one or more tasks associated with one or more of the parameter value module, the simulation module, and the calibration module.

The device may include code for providing connections in the first pre-route layout model based on a result of the first pre-route simulation to generate a routed layout model.

The device may include code for adjusting the first pre-route layout model based on a result of the first pre-route simulation to generate a second pre-route layout model.

The device may include the following elements: code for determining layout parameter values associated with the first set of elements of the electrical circuit based on a preliminary schematic model, wherein the layout parameter values may include one or more layout-dependent effect parameter values; code for using the layout parameter values to perform a first pre-placement simulation before the first pre-route layout model is generated; and code adjusting the preliminary schematic model based on a result of the first pre-placement simulation to generate the first schematic model.

The first pre-placement simulation may involve using the preliminary schematic model.

The first pre-placement simulation may involve using an exclusive schematic model. The exclusive schematic model may represent a second set of elements of the electrical circuit other than the first set of elements of the electrical circuit. The first set of elements of the electrical circuit may include critical elements of the electrical circuit.

The device may include the following elements: code for using the layout parameter values and an exclusive schematic model to perform a second pre-placement simulation; and code for adjusting the first schematic model based on a result of the second pre-placement simulation. The exclusive schematic model may represent a second set of elements of the electrical circuit other than the first set of elements of the electrical circuit. The first set of elements of the electrical circuit may include critical elements of the electrical circuit.

The device may include code for arranging the representations of the first set of elements of the electrical circuit based on a result of the first pre-placement simulation.

The device may include code for arranging representations of a second set of elements of the electrical circuit for forming the first pre-route layout model. The first pre-route simulation further involves using a second set of layout-dependent effect parameter values. The second set of layout-dependent effect parameter values may pertain to the second set of elements of the electrical circuit. An element of the first set of elements of the electrical circuit may be more sensitive to a layout-dependent effect than an element of the second set of elements of the electrical circuit.

The first set of elements of the electrical circuit may include analog circuit elements. The second set of elements of the electrical circuit may include digital circuit elements.

The device may include a non-transitory, tangible computer-readable storage medium that is configured to store computer-readable code for performing one or more of the aforementioned functions.

According to embodiments of the invention, layout-dependent effect parameter values may be incorporated in simulations in substantially early stages in a design process of an electrical circuit layout. Therefore, discrepancies between a routed layout model of the electrical circuit and a schematic model of the electrical circuit may be efficiently and effectively minimized, such that iterations of circuit simulations and schematic model revisions may be substantially minimized. Advantageously, satisfactory efficiency of the design process may be attained.

The above summary may be related to some of many embodiments of the invention disclosed herein and is not intended to limit the scope of the invention.

### BRIEF DESCRIPTION OF THE DRAWINGS

FIG. 1 shows a flowchart that illustrates steps in a method for designing (a layout of) an electrical circuit in accordance with one or more embodiments of the present invention.

FIG. 2 shows a schematic block diagram that illustrates modules in a device for designing (a layout of) an electrical circuit in accordance with one or more embodiments of the present invention.

FIG. 3 shows a flowchart that illustrates steps in a method for designing (a layout of) an electrical circuit in accordance with one or more embodiments of the present invention.

### DETAILED DESCRIPTION

Example embodiments of the present invention are described with reference to the accompanying drawings. As those skilled in the art would realize, the described embodiments may be modified in various different ways, all without departing from the spirit or scope of the present invention. Embodiments of the present invention may be practiced without some or all of these specific details. Well known process steps and/or structures may not have been described in detail in order to not unnecessarily obscure the present invention.

The drawings and description are illustrative and not restrictive. Like reference numerals may designate like (e.g., analogous or identical) elements in the specification. Repetition of description may be avoided.

The relative sizes and thicknesses of elements shown in the drawings are for facilitate description and understanding, without limiting the present invention. In the drawings, the thicknesses of some layers, films, panels, regions, etc., may be exaggerated for clarity.

Illustrations of example embodiments in the figures may represent idealized illustrations. Variations from the shapes illustrated in the illustrations, as a result of, for example, manufacturing techniques and/or tolerances, may be possible. Thus, the example embodiments should not be construed as limited to the shapes or regions illustrated herein but are to include deviations in the shapes. For example, an etched region illustrated as a rectangle may have rounded or curved features. The shapes and regions illustrated in the figures are illustrative and should not limit the scope of the example embodiments.

Although the terms “first”, “second”, etc. may be used herein to describe various elements, these elements, should not be limited by these terms. These terms may be used to distinguish one element from another element. Thus, a first element discussed below may be termed a second element without departing from the teachings of the present invention. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

If a first element (such as a layer, film, region, or substrate) is referred to as being “on”, “neighboring”, “connected to”, or “coupled with” a second element, then the first element can be directly on, directly neighboring, directly connected to, or directly coupled with the second element, or an intervening element may also be present between the first element and the second element. If a first element is referred to as being “directly on”, “directly neighboring”, “directly connected to”, or “directed coupled with” a second element, then no intended intervening element (except environmental elements such as air) may also be present between the first element and the second element.

Spatially relative terms, such as “beneath”, “below”, “lower”, “above”, “upper”, and the like, may be used herein for ease of description to describe one element or feature's spatial relationship to another element(s) or feature(s) as illustrated in the figures. It will be understood that the spatially relative terms may encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein should be interpreted accordingly.

The terminology used herein is for the purpose of describing particular embodiments and is not intended to limit the invention. As used herein, the singular forms, “a”, “an”, and “the” may indicate plural forms as well, unless the context clearly indicates otherwise. The terms “includes” and/or “including”, when used in this specification, may specify the presence of stated features, integers, steps, operations, elements, and/or components, but may not preclude the presence or addition of one or more other features, integers, steps, operations, elements, components, and/or groups.

Unless otherwise defined, terms (including technical and scientific terms) used herein have the same meanings as commonly understood by one of ordinary skill in the art related to this invention. Terms, such as those defined in commonly used dictionaries, should be interpreted as having meanings that are consistent with their meanings in the context of the relevant art and should not be interpreted in an idealized or overly formal sense unless expressly so defined herein.

The term “connect” may mean “electrically connect”. The term “insulate” may mean “electrically insulate”. The term “conductive” may mean “electrically conductive”

Unless explicitly described to the contrary, the word “comprise” and variations such as “comprises”, “comprising”, “include”, or “including” may imply the inclusion of stated elements but not the exclusion of other elements.

Various embodiments, including methods and techniques, are described in this disclosure. Embodiments of the invention may also cover an article of manufacture that includes a non-transitory computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable hardware circuits (such as electrical, mechanical, and/or optical circuits) adapted for the various operations pertaining to embodiments of the invention.

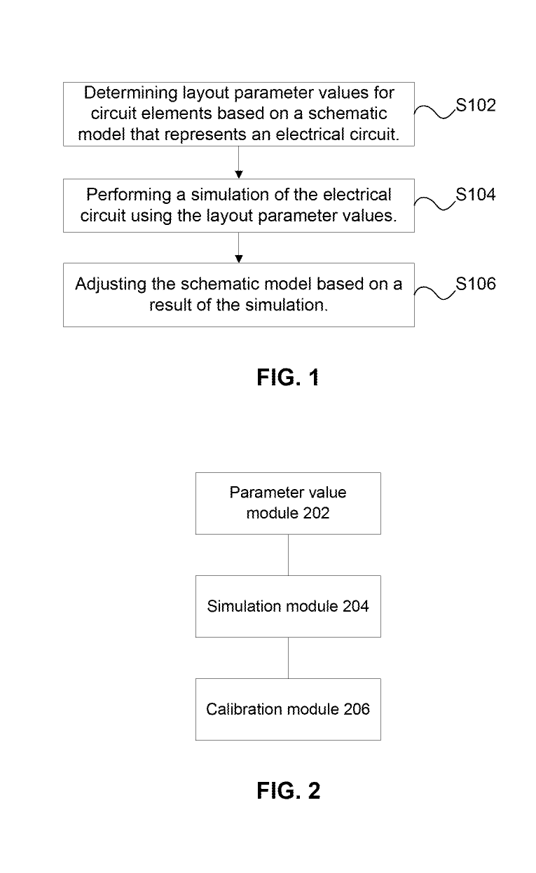

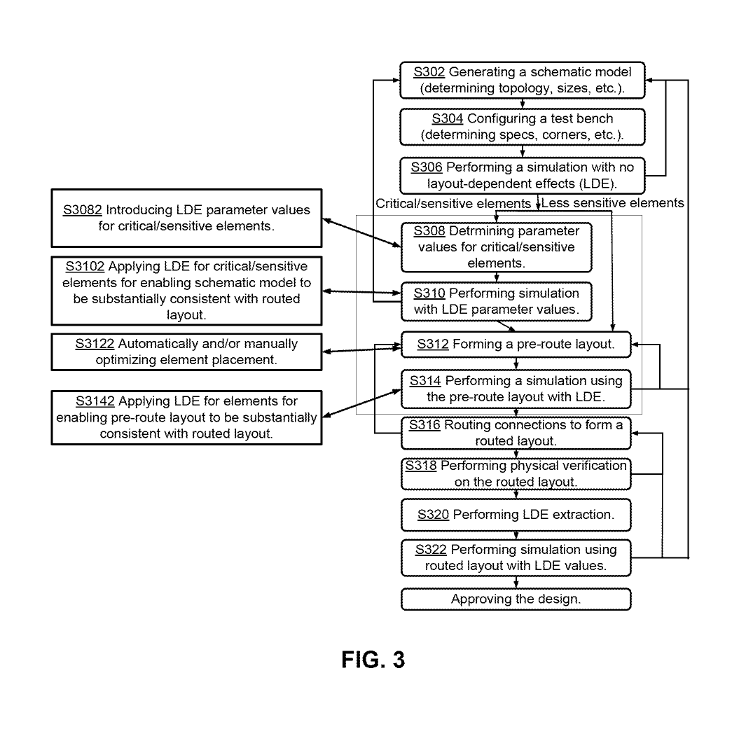

FIG. 1 shows a flowchart that illustrates steps in a method for designing (a layout of) an electrical circuit in accordance with one or more embodiments of the present invention. FIG. 2 shows a schematic block diagram that illustrates modules in a device for designing (a layout of) an electrical circuit in accordance with one or more embodiments of the present invention. FIG. 3 shows a flowchart that illustrates steps in a method for designing (a layout of) an electrical circuit in accordance with one or more embodiments of the present invention. One or more of the steps illustrated in FIG. 1 and FIG. 3 may be performed using a device that includes one or more of the modules illustrated in FIG. 2, one or more alternative modules, and/or one or more additional modules.

Referring FIG. 2, the device may include a parameter value module 202, a simulation module 204, and a calibration module 206. The device may include hardware that may be configured to perform one or more tasks associated with one or more of the parameter value module 202, the simulation module 204, and the calibration module 206. The device may include hardware and computer-readable code for performing one or more steps illustrated in FIG. 1 and FIG. 3. The device may include a non-transitory, tangible computer-readable storage medium that is configured to store the computer-readable code. In an embodiment, the device may be or may include a computer.

Referring to FIG. 1 and FIG. 2, the parameter value module 202 may be configured to perform a step S102, which may include determining layout parameter values for elements of an electrical circuit based on a schematic model (e.g., a schematic diagram) that represents an electrical circuit. The layout parameter values may include a first set of layout-dependent effect parameter values that may be related to layout-dependent effects. In an embodiment, the layout-dependent effects may include one or more parasitic effects (e.g., one or more parasitic capacitances, parasitic resistances, and/or parasitic inductances). The first set of layout-dependent effect parameter values may pertain to a first set of elements (e.g., critical elements, sensitive elements, and/or all elements) of the electrical circuit.

The simulation module 204 may be configured to perform a step S104, which may include performing a simulation of the electrical circuit using the layout parameter values.

In an embodiment, in the step S104, the simulation module 204 may perform a pre-placement circuit simulation using layout parameter values associated with critical elements of the electrical circuit and using an exclusive schematic model that represents non-critical elements (excluding the critical elements) of the electrical circuit.

In an embodiment, in the step S104, the simulation module 204 may perform a pre-placement circuit simulation using one or more layout-dependent effect models, for example, one or more of a length of thin oxide definition area (LOD) effect model, a well proximity effect model, a poly spacing effect model, etc.

In an embodiment, in the step 104, the simulation module 204 may perform a first pre-route circuit simulation using a first pre-route layout model and the first set of layout-dependent effect parameter values, wherein the first pre-route layout model may include representations of the first set of elements of the electrical circuit. The first pre-route layout model may further include representations of a second set of elements of the electrical circuit. The first set of elements of the electrical circuit may include critical elements of the electrical circuit; the second set of elements of the electrical circuit may include non-critical elements of the electrical circuit.

The calibration module 206 may be configured perform a step S106, which may include adjusting the schematic model based on a result of the simulation. In an embodiment, the calibration module 206 may adjust the schematic model based on a result of a pre-placement circuit simulation, a result of a pre-route circuit simulation (e.g., the first pre-route circuit simulation), corresponding performance parameters, and/or predetermined electrical circuit performance parameters to generate an adjusted schematic model.

Since the simulation in the step S104 and the adjustment in the step S106 may involve layout-dependent effect parameters and may be performed in substantial early stages in the design process, the final layout may be substantially consistent with (and/or may substantially approximate) the adjusted schematic model. Advantageously, satisfactory efficiency of the design process may be attained.

The device may include one or more detailed, additional, and/or alternative elements. The device may perform one or more detailed, additional, and/or alternative steps, such as one or more of the steps discussed with reference to FIG. 3.

FIG. 3 shows a flowchart that illustrates steps in a method for use in designing an electrical circuit layout in accordance with one or more embodiments of the present invention. The method may be implemented using a device that includes hardware and/or software. For example the device may be a computer. Referring to FIG. 3, the method may include steps S302, S304, S306, S308, S310, S312, S314, S316, S318, S320, and S322.

The step S302 may include generating a preliminary schematic model that represents the electrical circuit. The schematic model may specify one or more of a topology associated with the electrical circuit, sizes of elements of the electrical circuit, etc. The step S302 may include generating and/or selecting one or more layout-dependent effect models, such as one or more of a length of thin oxide definition area (LOD) effect model, a well proximity effect model, a poly spacing effect model, etc.

Subsequent to the step S302, the step S304 may include configuring a test bench (i.e., a computer-implemented virtual environment) for verifying the preliminary schematic model. The test bench may specify specifications and/or corners (e.g., related to fabrication parameter variations) pertaining to the electrical circuit.

Subsequent to the step S304, the step S306 may include using the preliminary schematic model and the test bench to perform a preliminary simulation (e.g., corner simulation) that may involve substantially no layout-dependent effects (and substantially no parasitic effects).

If necessary or desirable for optimizing the schematic model, subsequent to the step S306, the step S302 may be performed for adjusting the preliminary schematic model based on a result of the preliminary simulation to generate an adjusted preliminary schematic model.

In an embodiment, subsequent to the step S306, the method may include selecting a first set of elements of the electrical circuit. Elements of the first set of elements of the electrical circuit may be more sensitive to one or more layout-dependent effects than elements of a second set of elements of the electrical circuit.

In an embodiment, the first set of elements of the electrical circuit may include analog circuit elements, and the second set of elements of the electrical circuit may include digital circuit elements.

In an embodiment, the first set of elements of the electrical circuit may include critical elements of the electrical circuit, and the second set of elements of the electrical circuit may include non-critical elements or less-critical elements of the electrical circuit.

Subsequent to the step S306, the step S308 may include determining layout parameter values associated with the first set of elements of the electrical circuit based on the preliminary schematic model and/or the adjusted preliminary model. The layout parameter values may include one or more layout-dependent effect parameter values and/or constraint values. The step S308 may include a sub-step S3082, which may include introducing layout-dependent effect parameter values for critical elements and/or sensitive elements of the electrical circuit. The critical elements of the electrical circuit may be required for the electrical circuit to function properly. The sensitive elements of the electrical circuit may be substantially sensitive to one or more layout-dependent effects (which may include one or more parasitic effects).

Subsequent to the step S308, the step S310 may include using the layout parameter values to perform a first pre-placement simulation. The step S310 may include a sub-step S3102, which may include applying layout-dependent effect parameter values for critical elements for enabling the schematic model involved in the simulation to be substantially consistent with (and/or to substantially approximate) a routed layout model formed in a substantially late stage of the design process. Since the step S308 may be performed in a substantially early stage of the design process, the consistency between the schematic model and the routed layout model may advantageously enable maximization of the efficiency of the design process.

If necessary or desirable for optimizing the schematic model, subsequent to the step S310, the step S302 may be performed for adjusting the preliminary schematic model or the adjusted preliminary schematic model based on a result of the first pre-placement simulation to generate a first schematic model.

In an embodiment, the first pre-placement simulation may involve using the preliminary schematic model and/or the adjusted preliminary schematic model.

In an embodiment, the first pre-placement simulation may involve using an exclusive schematic model. The exclusive schematic model may represent the second set of elements of the electrical circuit other than the first set of elements of the electrical circuit.

In an embodiment, the method and/or the step S310 may include the following steps: using the layout parameter values and an exclusive schematic model to perform a second pre-placement simulation, wherein the exclusive schematic model may represent the second set of elements of the electrical circuit other than the first set of elements of the electrical circuit.

If necessary or desirable for optimizing the schematic model, subsequent to the step S310, the step S302 may be performed for adjusting the first schematic model based on a result of the second pre-placement simulation to generate a second schematic model.

Subsequent to the step S310, the step S312 may include placing (and/or arranging) representations of the first set of elements of the electrical circuit and/or representations of the second set of elements of the electrical circuit for forming a first pre-route layout model. The step S312 may include a sub-step S3122, which may include automatically and/or manually optimizing placement (and/or arrangement) of the representations of the first set of elements of the electrical circuit and/or the representations of the second set of elements of the electrical circuit based on a result of the first pre-placement simulation and/or a result of the second pre-placement simulation.

In an embodiment, the step S312 may include the following steps: automatically arranging the representations of the first set of elements and/or the representations of the second set of elements according to an algorithm stored in the device; and after the automatically arranging, adjusting positions of the representations of the first set of elements and/or the representations of the second set of elements according to user input.

In an embodiment, the representations of the first set of elements are placed and/or arranged as a single unit.

In an embodiment, the first set of elements of the electrical circuit may be digital circuit elements and/or may not be substantially sensitive to layout-dependent effects, and the steps S308 and S310 may be omitted.

Subsequent to the step S312, the step S314 may include using the first pre-route layout model and a first set of layout-dependent effect parameter values to perform a first pre-route simulation. The first set of layout-dependent effect parameter values may pertain to the first set of elements of the electrical circuit. The first pre-route simulation may further involve using a second set of layout-dependent effect parameter values. The second set of layout-dependent effect parameter values may pertain to the second set of elements of the electrical circuit. The step S314 may include a sub-step S3142, which may include applying layout-dependent effect parameter values for both the first set of elements and the second set of elements for enabling the first pre-route layout model to be substantially consistent (and/or to substantially approximate) with a routed layout model formed in a substantially late stage of the design process. Since the step S314 may be performed in a substantially early stage of the design process, the consistency between the first pre-route layout model and the routed layout model may advantageously enable maximization of the efficiency of the design process.

If necessary or desirable for optimizing the schematic model, subsequent to the step S314, the step S302 may be performed for adjusting the preliminary schematic model, the adjusted preliminary schematic model, the first schematic model, or the second schematic model based on a result of the first pre-route simulation to generate a third schematic model.

If necessary or desirable for optimizing the pre-route layout model, subsequent to the step S314, the step S312 may be performed for adjusting the first pre-route layout model based on a result of the first pre-route simulation to generate a second pre-route layout model.

Subsequent to the step S314, the step S316 may include providing connections in the first pre-route layout model or the second pre-route layout model based on a result of the first pre-route simulation to generate a routed layout model.

In an embodiment, the step S314 may include using the second pre-route layout model and at least one of the first set of layout-dependent effect parameter values and a second set of layout-dependent effect parameter values to perform a second pre-route simulation, and the step S316 may include providing connections in the second pre-route layout model based on a result of the second pre-route simulation to generate a routed layout model.

Subsequent to the step S316, the step S318 may include performing physical verification on the routed layout model.

If necessary or desirable for optimizing the routed layout model, subsequent to the step S318, the step S316 may be performed for adjusting the routed layout model based on a result of the physical verification to generate an adjusted routed layout model.

Subsequent to the step S318, the step S320 may include performing layout-dependent effect extraction on the routed layout model or the adjusted layout model to obtain substantially realistic and/or accurate extracted layout-dependent effect parameter values (which may include parasitic effect parameter values).

Subsequent to the step S320, the step S322 may include performing a routed layout simulation (or circuit simulation) using the extracted layout-dependent effect parameter values and the routed layout model (or the adjusted layout model) to verify the electrical circuit layout design.

If necessary or desirable for optimizing the routed layout model and/or the schematic model, subsequent to the step S322, the step S316 may be performed for adjusting the routed layout model, and/or the step S302 may be performed for adjusting the schematic model.

Since layout-dependent effects have been taken into account in substantial early steps, e.g., the steps S310 and S314, of the design process, iterations between the step S322 and the step S316 and/or iteration between the step S322 and the step S302 may be minimized. Advantageously, the design process may be substantially efficient.

The layout design of the electrical circuit may be approved based on a result of the step S322.

One or more embodiments of the present invention may be related to a device that may include computer-readable code for performing one or more of the steps discussed with reference to FIG. 3 and may include a non-transitory, tangible computer-readable storage medium for storing the computer-readable code.

According to embodiments of the invention, layout-dependent effect parameter values may be incorporated in simulations in substantially early stages in a design process of an electrical circuit layout. Therefore, discrepancies between a routed layout model of the electrical circuit and a schematic model of the electrical circuit may be substantially minimized, such that iterations of circuit simulations and schematic model revisions may be minimized. Advantageously, satisfactory efficiency of the design process may be attained.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A method for designing an electrical circuit, the method being implemented using a device that includes hardware, the method comprising:
generating a first schematic model that represents the electrical circuit;
placing representations of a first set of elements of the electrical circuit for forming a first pre-route layout model; and
using the first pre-route layout model and a first set of layout-dependent effect parameter values to perform a first pre-route simulation, wherein the first set of layout-dependent effect parameter values pertains to the first set of elements of the electrical circuit.

2. The method of claim 1, further comprising: adjusting the first schematic model based on a result of the first pre-route simulation to generate a second schematic model.

3. The method of claim 1, further comprising: providing connections in the first pre-route layout model based on a result of the first pre-route simulation to generate a routed layout model.

4. The method of claim 1, further comprising: adjusting the first pre-route layout model based on a result of the first pre-route simulation to generate a second pre-route layout model.

5. The method of claim 4, further comprising: using the second pre-route layout model and at least one of the first set of layout-dependent effect parameter values and a second set of layout-dependent effect parameter values to perform a second pre-route simulation.

6. The method of claim 4, further comprising: providing connections in the second pre-route layout model based on a result of the second pre-route simulation to generate a routed layout model.

7. The method of claim 1, further comprising:
determining layout parameter values associated with the first set of elements of the electrical circuit based on a preliminary schematic model, wherein the layout parameter values includes one or more layout-dependent effect parameter values;
before the placing, using the layout parameter values to perform a first pre-placement simulation; and
adjusting the preliminary schematic model based on a result of the first pre-placement simulation to generate the first schematic model.

8. The method of claim 7, wherein the first pre-placement simulation involves using the preliminary schematic model.

9. The method of claim 7, wherein the first pre-placement simulation involves using an exclusive schematic model, and wherein the exclusive schematic model represents a second set of elements of the electrical circuit other than the first set of elements of the electrical circuit.

10. The method of claim 7, further comprising:
using the layout parameter values and an exclusive schematic model to perform a second pre-placement simulation, wherein the exclusive schematic model represents a second set of elements of the electrical circuit other than the first set of elements of the electrical circuit; and
adjusting the first schematic model based on a result of the second pre-placement simulation.

11. The method of claim 7, further comprising: selecting the first set of elements of the electrical circuit, wherein an element of the first set of elements of the electrical circuit is more sensitive to a layout-dependent effect than an element of a second set of elements of the electrical circuit.

12. The method of claim 7, wherein the first set of elements of the electrical circuit includes analog circuit elements.

13. The method of claim 7, further comprising:
placing representations of a second set of elements of the electrical circuit for forming the first pre-route layout model,
wherein the first pre-route simulation further involves using a second set of layout-dependent effect parameter values,
wherein the second set of layout-dependent effect parameter values pertains to the second set of elements of the electrical circuit, and
wherein an element of the first set of elements of the electrical circuit is more sensitive to a layout-dependent effect than an element of the second set of elements of the electrical circuit.

14. The method of claim 13, wherein the first set of elements of the electrical circuit includes analog circuit elements, and wherein the second set of elements of the electrical circuit includes digital circuit elements.

15. The method of claim 1, wherein the placing comprises:
automatically arranging the representations of the first set of elements according to an algorithm stored in the device; and
after the automatically arranging, adjusting positions of the representations of the first set of elements according to user input.

16. A device for designing an electrical circuit, the device comprising:
a parameter value module configured to determine a first set of layout-dependent effect parameter values, wherein the first set of layout-dependent effect parameter values pertains to a first set of elements of the electrical circuit;
a simulation module configured to perform a first pre-route simulation using a first pre-route layout model and the first set of layout-dependent effect parameter values, wherein the first pre-route layout model includes representations of the first set of elements of the electrical circuit;
a calibration module configured to adjust a first schematic model based on a result of the first pre-route simulation to generate a second schematic model; and
hardware configured to perform one or more tasks associated with one or more of the parameter value module, the simulation module, and the calibration module.

17. The device of claim 16, comprising: code for adjusting the first pre-route layout model based on a result of the first pre-route simulation to generate a second pre-route layout model.

18. The device of claim 16, comprising:
code for determining layout parameter values associated with the first set of elements of the electrical circuit based on a preliminary schematic model, wherein the layout parameter values includes one or more layout-dependent effect parameter values;
code for using the layout parameter values to perform a first pre-placement simulation before the first pre-route layout model is generated; and
code adjusting the preliminary schematic model based on a result of the first pre-placement simulation to generate the first schematic model.

19. The device of claim 18, wherein the first pre-placement simulation involves using an exclusive schematic model, and wherein the exclusive schematic model represents a second set of elements of the electrical circuit other than the first set of elements of the electrical circuit.

20. The device of claim 18, comprising:
code for using the layout parameter values and an exclusive schematic model to perform a second pre-placement simulation, wherein the exclusive schematic model represents a second set of elements of the electrical circuit other than the first set of elements of the electrical circuit; and
code for adjusting the first schematic model based on a result of the second pre-placement simulation.
